(19) United States
(12) Patent Application Publication
(10) Pub. No.: US 2011/0122858 A1
(43) Pub. Date: May 26, 2011

(54) WIRELESS TRANSMITTER-RECEIVER AND MOBILE OBJECT MANAGEMENT SYSTEM

(76) Inventors: Yuichi YASHIRO, Kasumigaura (JP); Tsutomu Ito, Tsuchiura (JP); Takafumi Aki, Tsuchiura (JP)

(21) Appl. No.: 12/946,906

(22) Filed: Nov. 16, 2010

(30) Foreign Application Priority Data
Nov. 16, 2009 (JP) 2009-260637

(51) Int. Cl. H04W 84/02

(52) U.S. Cl. 370/338

(57) ABSTRACT

A concise and low cost mobile object management system which is capable of monitoring a state of a mobile object via a wireless transmitter-receiver having a wireless LAN function is provided. The mobile object management system includes a sensor for acquiring various information of a mobile object, a clock information acquisition unit, a memory unit for storing data, and a wireless LAN transmitter-receiver unit, each controlled by a Central Processing Unit, and transmits wirelessly a state of a measured object on the mobile object, location information, and clock information. By adopting a wireless LAN for the wireless transmitting and receiving function, it is possible to implement a concise and low cost system which is highly versatile and capable of utilizing a most common infrastructure.

### CROSS REFERENCE TO RELATED APPLICATION

The present application claims benefit of the filing dates of Japanese Patent Application No. 2009-260637 filed on Nov. 16, 2009, which is incorporated herein by reference.

### BACKGROUND OF THE INVENTION

1. Field of the Invention

The present invention relates to a wireless transmitter-receiver that transmits and receives status and location information of a mobile object via a wireless LAN (Local Area Network), and to a mobile object management system.

2. Description of the Related Art

In recent years, a wireless sensor network system gathers attention as a fundamental technology of a new network system for transmitting various types of information. A wireless sensor network system includes, a wireless terminal equipped with sensors for sensing humidity/temperature, pressure, oscillation, sound, location, and other information, and a wireless transmitting and receiving means for the sensed information. In other words, a sensor terminal which includes various types of sensors and a wireless transmitting and receiving function eliminates the necessity of wirings for transmitting sensor information.

Installing such wireless terminals on various places makes it possible to collect various types of information measured by the sensor.

In addition, a wireless terminal can be used in various situations since it does not require wiring and can avoid wire breaking, for example, caused by a disaster such as an earthquake. Further, it can be easily installed to an existing building without being affected by a layout change of sensing objects.

For implementing a wireless sensor network system, the required minimum components are: a wireless sensor terminal for transmitting information sensed by the sensors, a data collection terminal for receiving sensor information transmitted from the wireless sensor terminal, and wireless media for establishing communication between the wireless sensor terminal and the data collection terminal.

For example, when implementing a system in a closed area of a building, a data server such as a PC (Personal Computer) or a work station may be used as a data collection terminal. These data collection terminals are connected to a dedicated line such as LAN (Local Area Network) in the building, and the dedicated line is connected to a wireless gateway such as a hub or a LAN switch.

In this way, wireless sensor terminals disposed in predetermined plural locations in the building transmit sensor information to the data collection terminal by accessing the wireless gateway via wireless media such as IEEE802.11b wireless LAN or the like.

In the above case, near field wireless communication methods that cover a communication distance not longer than 100 m such as ZigBee®, Bluetooth®, extremely low power radio, specified low power radio, or wireless LAN may be used as a wireless network standard for the wireless media. Basically, most of the method above do not require permission and can be used for personal use, or do charge for wireless transmitting and receiving.

When implementing a wireless sensor network system that transmits and receives sensor information regardless of the location (i.e. wireless communication) unlike the closed area described above, a wireless transmitting and receiving method that covers long distance communication is required.

In this case, sensor information is collected in a building by using a near field wireless communication or a wire communication, and the sensor information is put together to a long distance wireless communication transmitting terminal, and then the sensor information is transmitted to a data server located on a distant building via a long distance wireless communication.

It is difficult for a single industry association or a personal user to install an infrastructure of wireless media for supporting wireless communication between the long distance wireless communication transmitting terminals above. For this reason, in many cases, an infrastructure of a big carrier is used. The infrastructure is, for example, a cellular telephone, PHS® (Personal Handy-Phone System), or WiMAX® (World interoperability for Microwave Access). Accordingly, in a case where a long distance wireless communication is used, communication charge is required for using the infrastructure of a carrier. The communication charge can be huge depending on the volume of sensor information and scale of the sensor network.

In the examples of two sensor network systems above, the measured objects are fixed to specific locations respectively.

Next, a case where a measured object is a mobile object will be explained. The mobile object is, for example, a transporting vehicle like a track or automobile traveling on the road. The sensor information acquired by a sensor includes, for example, status of on-board equipments, status of cargo on the vehicle and so forth. The term “cargo” used in this application means all transportable objects such as general goods including food like fish and seafood, and animals and plants, human etc. In recent years, problems that are related to securing food safety are closed up, and therefore a demand for humidity/temperature management etc. of the food during transport is increasing.

Further, as described below, a humane and an animal may be regarded as mobile objects, and attaching a sensor to a human or animal body for collecting sensor information has been focused on as an application of a sensor network system. That is, a human and an animal are regarded as mobile objects and information collected with a sensor may be, for example, a body temperature or a pulse rate of a human (or an animal) at a hospital or welfare facility (or zoo, animal hospital), which may be used for health management. Further, safety management like falling detection of workers, and labor management like monitoring working condition are discussed as another possible application.

A sensor network system for mobile objects usually puts importance on location information in addition to sensor information. For example, it is possible to see what is going on during transportation by collecting detailed information, such as routing information of a track, location of goods and people etc. in addition to sensor information. In this case, location information acquiring means is used such as a GPS (Global Positioning System), a trilateration method via wireless communication and the like. Since a GPS system uses satellite communications, which cannot be used inside a building. Therefore, it is difficult to obtain accurate information like room location in a building. Meanwhile, a satellite positioning system like a GPS system above is also considered as a sensor system called a positioning sensor. However, in the present application, information acquired by a GPS system or a result of trilateration is handled as location information.

In a case a travel distance is large when a mobile object travels between buildings being far apart, it is difficult to build up an infrastructure of long distance wireless communications covering the whole area by using a sensor network system based on the above mentioned near field wireless communication. Accordingly, in such a case, a communication system provided by a carrier is used. In addition, some other methods for collecting information of a mobile object are disclosed in related arts.

For example, Japanese Patent Application Laid-open JP2000-302211 or JP1998-302189 discloses a way in which wireless communication is not used but a data logger is placed on a mobile object for storing sensor data therein, and the sensor information stored during the travel is manually collected when the mobile object arrives at a certain building. In addition, JP2007-324945 or JP2009-9294 discloses another way, in which sensor information on a mobile object is transmitted in real-time via a long distance wireless communication system like a cellular telephone. Further, JP2005-71295 discloses a way in which a near field wireless communication means and a logger means are disposed on a mobile object, and sensor information during the travel is stored by the logger means and then the stored information is transmitted via the near field wireless communication when the mobile object arrives at a certain building.

As stated above, conventional technologies disclose some methods for acquiring a status of a mobile object or cargo on a mobile object via a sensor and collecting the information acquired by the sensors. In other words, such a system is already known in which sensor information including location information of a mobile object is acquired and is transmitted via a specific communication method.

In a case when a wireless transmitting and receiving means is not available while the mobile object is travelling, sensor information acquired during the travel may be stored in a data logger as described in JP2000-302211 and JP1998-302189.

In such a case however, extra work is required such as, manually removing the logger after the travel for collecting the stored sensor information, or manually reading out the sensor information on site via a handy terminal having infrared communication feature or the like, and further writing the sensor information to a data server like a PC or a work station. In addition, extra work is required such as transmitting the sensor data to a data server, or displaying the data on a SCADA (supervisory control and data acquisition system) and so forth, which results in increase of working hours and employment cost.

In a case where an infrastructure of wireless transmitting and receiving communication is available as described in JP2007-324945 and JP2009-9294, sensor information may be transmitted to a data server via a long distance wireless communication like a cellular telephone, PHS, WiMAX which are provided by a big carrier. However, although labor cost is not necessary as the information is automatically transmitted, huge communication charge may be required depending on the system size.

In an embodiment of JP2007-324945, a GPS system is used as a location information acquiring means, but it cannot be used inside a building. Due to this reason, the location information can be acquired when traveling outdoor, but detailed information like specifying a room when traveling in a building cannot be obtained.

To solve the problem above, for monitoring a mobile object with a low cost, as disclosed in JP2005-71295 for example, sensor information is stored when traveling, and after traveling and arrives at a building the information is transmitted automatically via near field wireless communication in the building from an access point (AP: Access Point) in a sensor station. In this case, manpower cost is not necessary as the information is transmitted automatically, and communication cost can be low as near field wireless communication is used.

However, in an example of JP2005-71295, a mobile object is limited to a track. Further, the mobile object is limited to a container which is carried on the track, and a sensor station is driven by a power source of the track. Therefore, the sensor station requires an external power source which should be always located on the track. In addition, the sensor station is separated from the sensor which is located in the measured object (container), and the sensor information is transmitted to the sensor station via the wireless function of the sensor. Therefore, the sensor information cannot be transmitted if the measured object (container) is unloaded from the track.

In other words, the embodiment of JP2005-71295 can be applied only to data acquisition while the mobile object is traveling. So, it is required to collect the information by other means after the measured object (container) is unloaded or when traveling in a building during or after the transportation, which makes the seamless data collection difficult. Accordingly, time and money may be wasted in the long run. In addition, the embodiment of JP2005-71295 adopts a GPS system for a location information acquiring means which cannot be used inside the building. Due to this reason, the location information can be acquired when traveling outdoor, but detailed information like room location when traveling in a building cannot be obtained.

In light of the problems above, an object of the present invention is to provide a wireless transmitter-receiver and a mobile object management system that can collect sensor information and refer to the status of the measured object with time and location information with low cost and time.

### SUMMARY OF THE INVENTION

For solving the problems above, there is provided a wireless transmitter-receiver described in claim 1, including: a sensor that acquires one or more pieces of information; a location information acquisition unit; a clock information acquisition unit; a clock function unit that stores the clock information; a wireless LAN transmitter-receiver unit; and a central processing unit that controls each unit; wherein the wireless transmitter-receiver periodically and wirelessly transmits the sensor information, the location information, and the clock information within a coverage area of a wireless LAN access point.

The wireless transmitter-receiver described in claim 2 is a wireless transmitter-receiver according to claim 1 further comprising a memory unit including a writable and erasable nonvolatile memory, wherein: the memory unit stores the sensor information, the location information, and the clock information in a case when the wireless transmitter-receiver is outside the coverage area of the wireless LAN access point or when wireless communication is not available; and the central processing unit controls the wireless LAN transmitter-receiver unit to transmit the sensor information, the location information, and the clock information stored in the memory unit, upon the wireless LAN transmitter-receiver unit becoming connectable to the wireless LAN access point.

The wireless transmitter-receiver described in claim 3 is a wireless transmitter-receiver according to claim 1, wherein: the location information acquisition unit is a GPS; the wireless transmitter-receiver performs under control of the Central Processing Unit, acquiring location information from the GPS in a case when the wireless transmitter-receiver can communicate with a GPS satellite and is outside the coverage area of the wireless LAN access point, and in a case when the wireless transmitter-receiver is inside the coverage area of the wireless LAN access point even though the wireless transmitter-receiver can communicate with the GPS satellite, not acquiring location information from the GPS, scanning a signal generated periodically from the wireless LAN access point, authenticating and connecting with the wireless LAN access point that has a highest signal level, acquiring wireless LAN access point information, transmitting the sensor information, the location information, and the clock information via a data packet to a data server; and the data server acquires more detailed information in addition to the location information from the GPS by making correspondence in advance between a wireless LAN access point and location information thereof.

The wireless transmitter-receiver described in claim 4 is a wireless transmitter-receiver according to claim 1, wherein the Central Processing Unit performs: registering information for an authentication of the wireless LAN access point in advance, the information including an SSID, a MAC address, a cryptography key, a wireless channel, and building information where the wireless LAN access point is installed; firstly, finding a building where the wireless transmitter-receiver is present using a scanning result of all channels scanned by the wireless LAN transmitter-receiver unit; and from a next time, scanning only channels used in the wireless LAN access point installed in the building.

The wireless transmitter-receiver described in claim 5 is a wireless transmitter-receiver according to claim 1, wherein the Central Processing Unit includes a real-time OS and performs: creating a task for a wireless function and a task other than the wireless function, calling periodically the task other than the wireless function when not using the wireless function, and calling periodically the task for the wireless function when using the wireless function.

The wireless transmitter-receiver described in claim 6 is a wireless transmitter-receiver according to claim 3, wherein: the clock information acquisition unit acquires a clock time using an NTP protocol under control of the Central Processing Unit; the location information acquisition unit acquires clock information from the GPS if the wireless transmitter-receiver can communicate with the GPS satellite and is outside the coverage area of the wireless LAN access point; the location information acquisition unit does not acquire location information from the GPS but acquires a Coordinated Universal Time from the NTP server via the NTP protocol if the wireless transmitter-receiver is inside the coverage area of the wireless LAN access point even if the wireless transmitter-receiver can communicate with the GPS satellite; and the acquired clock information is stored in the clock function unit; the wireless transmitter-receiver acquires clock information from the clock function unit in a case when the wireless transmitter-receiver cannot communicate with the GPS satellite and is outside the coverage area of the wireless LAN access point.

The wireless transmitter-receiver described in claim 7 is a wireless transmitter-receiver according to claim 1, wherein: the wireless LAN transmitter-receiver unit communicates wirelessly with a general purpose wireless LAN access point via IP communication and transmits data to a data server over the Internet under control of the Central Processing Unit, whereby the wireless transmitter-receiver monitors the sensor information, the location information, and the clock information.

The wireless transmitter-receiver described in claim 8 is a wireless transmitter-receiver according to claim 1, wherein the wireless LAN transmitter-receiver unit transmits an e-mail including the sensor information, the location information, the clock information, and alarm, to a cellular telephone or a personal computer directly using a SMTP protocol without intervention of a mail server.

The wireless transmitter-receiver described in claim 9 is a wireless transmitter-receiver according to claim 1, wherein the Central Processing Unit performs: registering to a public wireless LAN access point in advance an SSID, a MAC address, a cryptography key, and a wireless channel of the public wireless LAN access point; registering, in addition to the information above, an ID and a password for authentication using an HTTP protocol; and controlling the wireless LAN transmitter-receiver unit for performing authentication and connection automatically if the wireless transmitter-receiver is inside the coverage area of the wireless LAN access point.

The wireless transmitter-receiver described in claim 10 is a wireless transmitter-receiver according to claim 1 wherein: the wireless transmitter-receiver is installed in a mobile object; the mobile object is a measured object of the sensor; and the wireless transmitter-receiver transmits the sensor information, the location information, and the clock information, acquired from the mobile object.

The wireless transmitter-receiver described in claim 11 is a wireless transmitter-receiver according to claim 10 wherein: the mobile object is a transportation vehicle; the sensor includes a humidity/temperature sensor or an acceleration sensor disposed on a cargo of the vehicle for monitoring a status of the cargo.

The wireless transmitter-receiver described in claim 12 is a wireless transmitter-receiver according to claim 10 wherein: the mobile object is a human body; the sensor includes a body temperature sensor or a pulse sensor for monitoring a status of the human body.

The wireless transmitter-receiver described in claim 13 is a wireless transmitter-receiver according to claim 10 wherein: the mobile object is an animal body; the sensor includes a body temperature sensor or a pulse sensor for monitoring a status of the animal body.

A mobile object management system described in claim 14 includes: a data server connected to the Internet; a wireless transmitter-receiver disposed on a mobile object and connected to the Internet; and a monitor terminal connected to the Internet; wherein: the data server is accessible from the monitor terminal for browsing as an ASP (Application Service Provider; the wireless transmitter-receiver includes, a sensor that acquires one or more pieces of information, a location information acquisition unit, a clock information acquisition unit, a clock function unit that stores the clock information, a wireless LAN transmitter-receiver unit, and a central processing unit that controls each unit; and the wireless transmitter-receiver transmits the sensor information, the location information, and the clock information periodically and wirelessly within a coverage area of a wireless LAN access point.

As stated above, by utilizing a wireless transmitting and receiving terminal including a location information acquiring unit, a clock information acquisition unit, a clock function unit for storing a clock information, and a data storing means, which is driven by a battery with low power dissipation, and also utilizing a wireless LAN which is available as a standard worldwide with wireless media of a wireless sensor network, it becomes possible to monitor a measured object referring to a status with time and location information with low cost and time.

### BRIEF DESCRIPTION OF THE DRAWINGS

FIG. 1 is a block diagram of a wireless transmitter-receiver in accordance with an embodiment of the present invention;

FIG. 2 is a structure of a mobile object management system in accordance with an embodiment of the present invention;

FIGS. 3A to 3C are diagrams for explaining an authentication mechanism of a wireless LAN access point for a mobile object moving in a building in accordance with an embodiment of the present invention;

FIGS. 4A to 4C are diagrams for explaining an embodiment of a wireless LAN access point list and a location mechanism according to the present invention;

FIG. 5 is a diagram for explaining an embodiment of a mobile object management system according to the present invention;

FIGS. 6A to 6C are diagrams for explaining an embodiment of a wireless transmitter-receiver and a mobile object management system according to the present invention;

FIGS. 7A to 7C are diagrams for explaining an efficiency improvement in scanning a wireless LAN access point when a plurality of buildings are registered in an embodiment of wireless transmitter-receiver and a mobile object management system according to the present invention;

FIG. 8 shows a flowchart of a procedure of a measurement task of a wireless transmitter-receiver in accordance with an embodiment of the present invention;

FIG. 9 shows a flow chart of a procedure of a scanning task of a wireless transmitter-receiver in accordance with an embodiment of the present invention;

FIG. 10 shows a diagram of a mobile object management system including a service area of a public wireless LAN access point in accordance with an embodiment of the present invention; and

FIG. 11 shows a diagram for explaining an embodiment of a wireless transmitter-receiver and a mobile object management system for the purpose of maintaining human's health in accordance with an embodiment of the present invention.

### DETAILED DESCRIPTION OF THE PREFERRED EMBODIMENTS

Referring to drawings, some embodiments of the present invention will be explained below. In addition, because the same components will be denoted by the same reference numerals in the drawings, a duplicated explanation will be omitted.

### Embodiment 1

Embodiment 1 of the present invention is a wireless transmitter-receiver including: a sensor that acquires one or more pieces of information; a location information acquisition unit; a clock information acquisition unit; a clock function unit that stores the clock information; a memory unit for storing data; a wireless LAN transmitter-receiver unit; and a central processing unit that controls each unit; wherein the wireless transmitter-receiver periodically and wirelessly transmits the sensor information, the location information, and the clock information within a coverage area of a wireless LAN access point.

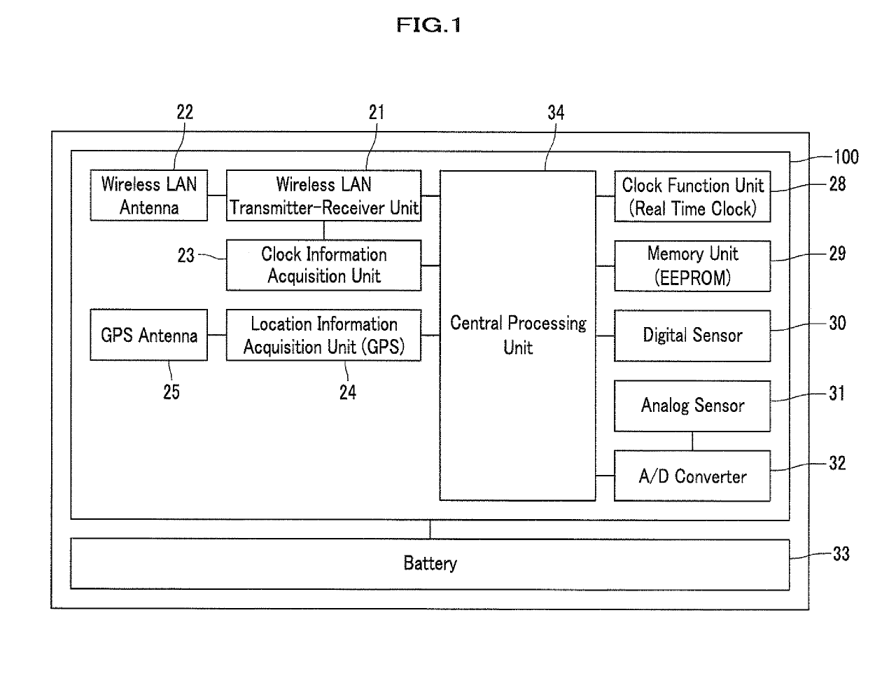

A structure of a wireless transmitter-receiver in accordance with Embodiment 1 of the present invention will be explained by referring to FIG. 1. FIG. 1 shows a block diagram of a wireless transmitter-receiver in accordance with an embodiment of the present invention. A numeric character 20 denotes a wireless transmitter-receiver according to the present invention, 100 a main body of the wireless transmitter-receiver, 33 a battery that supplies power to the wireless transmitter-receiver main body 100, 21 a Wireless LAN transmitter-receiver unit, 22 a wireless LAN antenna, 23 a clock information acquisition unit, 24 a location information acquisition unit (GPS), 25 a GPS antenna, 28 a clock function unit (real-time clock), 29 a memory unit, 30 a digital sensor, 31 an analog sensor, 32 a A/D Converter, and 34 a Central Processing Unit respectively.

In the wireless transmitter-receiver 20 shown in FIG. 1, the wireless transmitter-receiver main body 100 is equipped with a Central Processing Unit 34 and other peripheral components disposed around it, such as a wireless LAN transmitter-receiver unit 21, a clock information acquisition unit 23, a location information acquisition unit 24, a clock function unit 28, a memory unit 29, a digital sensor 30, and a A/D Converter 32. The Central Processing Unit 34 controls these components, the wireless LAN transmitter-receiver unit 21, the clock information acquisition unit 23, the location information acquisition unit 24, a clock function unit 28, a memory unit 29, a digital sensor 30, and an A/D Converter 32.

The wireless LAN transmitter-receiver unit 21 is wireless media for data transmission, and is connected to the Central Processing Unit 34. In addition, the wireless LAN transmitter-receiver unit 21 transmits data such as sensor data and receives data from other stations via the wireless LAN antenna 22 using radio waves.

The wireless transmitter-receiver main body 100 is equipped with at least one of the digital sensor 30 and the analog sensor 31, and acquires various types of information from a mobile object, then outputs the acquired information to the Central Processing Unit 34. The analog sensor 31 outputs the sensor information, which is digitized by the A/D Converter 32, to the Central Processing Unit 34.

A digital sensor, for example, has a serial communication interface mainly used in a embedded micro controller system such as UART (Universal Asynchronous Receiver Transmitter), SPI (Serial Peripheral Interface), I2C (Inter-Integrated Circuit), and returns sensor information responding to a request from the Central Processing Unit 34, or automatically and periodically transmits sensor information while the power is on. The Central Processing Unit 34 receives each sensor information and conducts a predetermined process for the each sensor information.

The location information acquisition unit 24 having a GPS acquires location information from a GPS satellite via the GPS antenna 25, and outputs the acquired information to the Central Processing Unit 34.

The Central Processing Unit 34 further includes the clock information acquisition unit 23, and if a wireless LAN communication is available, the Central Processing Unit 34 acquires a Coordinated Universal Time by an inquiry to an average NTP server using a NTP (Network Time Protocol) protocol via the wireless LAN transmitter-receiver unit 21. The Central Processing Unit 34, if a communication with a GPS satellite is available, may acquire a universal time included in a packet sent from the GPS satellite via the GPS communication. In such a case however, it is required to operate a GPS, which raises the power consumption of the whole wireless transmitter-receiver 20. Since the wireless LAN transmitter-receiver unit 21 is operated anyway in the data transmission, it may be preferable to acquire time information via the NTP server if the wireless LAN communication is in operation.

Herewith, by acquiring a universal time from the GPS or the NTP server and combining the sensor information therewith, it is possible to record a status of a measured object indicating at what time and in what condition. In addition, once the universal time is set to the clock function unit, the clock function unit operates always on the universal time, which eliminates the necessity of communicating with a GPS satellite and makes it possible to acquire clock information from the clock function unit even if it is outside the coverage area of the wireless LAN access point.

Here, the NTP protocol is a protocol by which network equipment synchronizes a clock therein on the proper clock time. The NTP servers are a server having the universal time, and are present at various places worldwide so that a universal time is returned responding to a time acquisition request from a client.

A typical GPS protocol is NMEA (NMEA: National Marine Electronics Association). This communication protocol was specified by the National Marine Electronics Association, and is used in a communication between a GPS receiver and equipment. In particular, NMEA-0183 is a standard for communication between a GPS receiver and navigation equipment via a serial interface. The NMEA provides several formats including one with a different digit number of location information or one that can acquire clock information.

The clock function unit 28 includes a real-time clock function and is connected to the Central Processing Unit 34. The Central Processing Unit 34 acquires a Coordinated Universal Time from the clock information acquisition unit 23 or from clock information in a GPS packet, and sets it on the real-time clock in the clock function unit 28. The clock function unit 28 always operates on the universal time, and returns clock information to the Central Processing Unit 34 on a time acquisition request.

The Central Processing Unit 34 periodically acquires a Coordinated Universal Time from the NTP server as long as wireless LAN communication is available within the coverage area of the wireless LAN access point. In a case where GPS communication is available but wireless LAN communication is not available, the Central Processing Unit 34 may acquire clock information included in data from the GPS satellite. In a case where the wireless transmitter-receiver is outside a coverage area of a wireless LAN access point and both wireless LAN communication and GPS communication are not available, the Central Processing Unit 34 may acquire clock information via the real-time clock.

The memory unit 29 is an external storage unit of the Central Processing Unit 34. The memory unit 29 is, for example, a nonvolatile memory such as EEPROM (Electrically Erasable Programmable Read Only Memory), and is connected to the Central Processing Unit 34. The memory unit 29 performs storing and loading (write and read) data in accordance with a write instruction or read instruction by the Central Processing Unit 34. The stored data includes, for example, sensor information, location information, clock information, terminal information, and wireless LAN access point information; depending on the purpose of a user.

By referring to data stored in the memory unit 29, it is possible to transmit the status of a mobile object with what time and what condition via wireless communication.

As stated above, a wireless LAN is a world's most commonly used wireless transmitting and receiving means which is available to anybody at low cost. It is a wireless communication standard compliant to IEEE.11, and in particular, IEEE.11g provides a 54 Mbps high-speed communication, and is becoming an essential feature for a mobile PC, a cellular telephone and the like.

A wireless LAN access points are installed widely in offices and factories, and even at home, which provides high accessibility.

In other words, since a wireless LAN access point compliant to IEEE.11 provides a communication feature using a standard protocol, it is possible to transmit data from anywhere via a wireless transmitter-receiver to a data server over the Internet (IP communication), and to monitor the data sent from all over the world at a single location. Here, IP stands for Internet Protocol, which is a protocol for communication over the Internet, and is an important and fundamental feature of the Internet. For transmitting sensor information to the Internet via near field wireless communication requires, a terminal is necessary for transmitting data to a cellular phone and converting data to an IP packet. In addition, cost for communication fee or time for developing a program is required. A wireless LAN provides an environment in which a wireless transmitter-receiver performs IP communication, communicates with a wireless LAN access point, and transmits data to the Internet directly, whereby reducing time and cost is allowed.

In addition, a wireless LAN access point called a public wireless LAN service is installed anywhere in the world and accessible by anybody free of charge. As stated above, infrastructures using a wireless LAN is already available to many places and facilities, which reduces the necessity for constructing a new infrastructure.

The near field wireless communication methods such as ZigBee®, Bluetooth®, and extremely low power radio are used in limited situations according to their characters but not widely used in general purpose. For this reason, a user has to construct an infrastructure when implementing a sensor network.

According to an embodiment using a wireless LAN described in FIG. 1, it is possible to reduce cost and time for constructing an infrastructure, and to transmit data directly to the Internet via wireless LAN access points disposed in various places.

Preferably, the communication with a GPS satellite should be available, which makes it possible to obtain location information from the GPS satellite, and record sensor information therewith. In addition, if it is inside the coverage area where a wireless LAN access point is accessible, location information while traveling inside the coverage area of a wireless LAN access point becomes available, including detailed information like room location, and this provides better traceability.

In the embodiment above, the signal generated periodically from the wireless LAN access point is called a beacon signal, which includes a MAC (Media Access Control) address of the wireless LAN access point and SSID (Service Set IDentififier) information, and the intensity of the signal upon receiving is specified by RSSI (Receive Signal Strength Indication). Two scanning modes are standardized in IEEE802.11 for detecting a neighboring wireless LAN access point, i.e. passive scan and active scan. The passive scan is a mode in which a wireless transmitter-receiver detects a neighboring wireless LAN access point by monitoring a beacon periodically transmitted from the neighboring wireless LAN access point. In a case when neighboring wireless LAN access points use different channels, the wireless transmitter-receiver switches and scans the channels one by one for detecting a beacon. The active scan is a mode in which a wireless transmitter-receiver detects a neighboring wireless LAN access point by broadcasting a request packet and receives a response from a neighboring wireless LAN access point. The wireless transmitter-receiver sends a request packet and waits for a response packet until a predetermined waiting time set on a timer elapses. If a response packet is not received, the wireless transmitter-receiver switches to the next channel for sending another request packet.

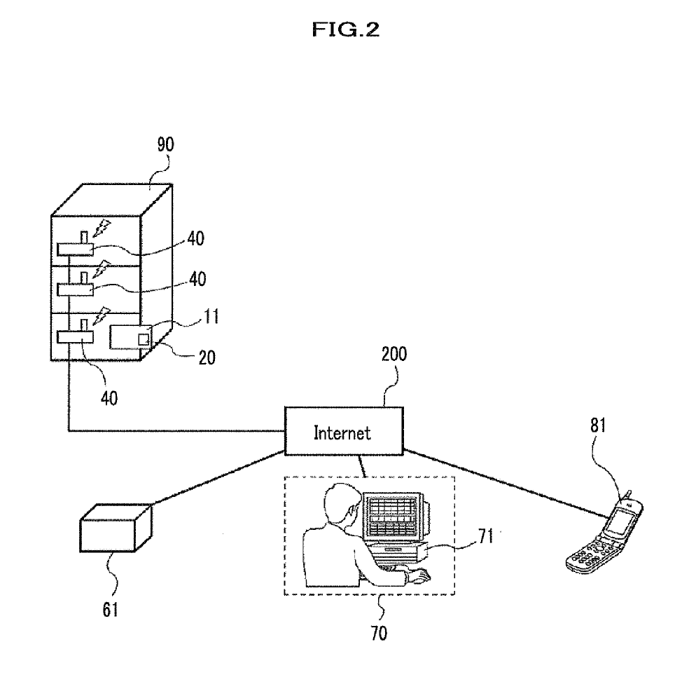

A wireless transmitter-receiver and a mobile object management system according to the present invention will be explained by referring to FIG. 2. FIG. 2 shows a structure of a mobile object management system in accordance with an embodiment of the present invention. A numeric character 200 denotes the Internet,90 a building,61 a data server,70 a monitor station,71 a monitor terminal disposed in the monitor station 70,81 a cellular telephone, 11 a measured object, and 40 a access point respectively.

An embodiment of a basic mobile object management system will be explained by referring to FIG. 2. One or more wireless LAN access points 40 are disposed in the building 90 and the whole building 90 is covered by the coverage area of one or more wireless LAN access points.

In this case, each wireless LAN access point 40 holds an arbitrary SSID (Service Set IDentifier), a channel, and a cryptography key, and each wireless transmitter-receiver 20 holds information of a corresponding wireless LAN access point 40. A wireless LAN access point 40 is connected to a wired LAN in the building 90, establishing a local area network, and then connected to the Internet 200.

Meanwhile, a data server 61 is also connected to the Internet 200. The data server 61 may be disposed either inside or outside, like shown in FIG. 2, the building 90 as long as it is connected to the Internet 200.

In a case when the wireless transmitter-receiver 20 which is attached to a measured object 11 is present inside the building 90, the wireless transmitter-receiver 20 performs authentication to one of the wireless LAN access points in the building 90, and transmits each piece of data to the data server 61 via IP (Internet Protocol) communication. In the data transmission, popular communication protocol for IP communication such as UDP (User Datagram Protocol) or TCP (Transmission Control Protocol) is used. The data server 61 saves the received data.

For the authentication to the wireless LAN access point 40, the wireless transmitter-receiver 20 as stated before, registers information of a corresponding wireless LAN access point in advance, periodically scans the wireless LAN access points 40, creates a scan result list of the wireless LAN access points 40, compares the scan result list with the plurality of pieces of information of the wireless LAN access points, and performs authentication and connection only to the wireless LAN access points 40 the information of which matches the registered wireless LAN access point information.

As stated above, a wireless LAN is the most widely used near field wireless communication media. Therefore, even when the wireless transmitter-receiver 20 is located inside the building 90, it may detect a free wireless LAN access point that is not encrypted located around the building 90. Accordingly, for preventing connection to an undesirable network, it is effective not to perform authentication to a wireless LAN access point 40 that is not registered in advance.

In addition, an SSID and a cryptography key are registered in the wireless transmitter-receiver 20 in advance. Therefore, if the wireless LAN access point 40 is registered, the wireless transmitter-receiver 20 can exchange the cryptography key and perform authentication with the wireless LAN access point 40.

A monitor terminal 71 which is disposed at a monitor station 70 is connected to the Internet 200. It is possible to monitor data transmitted from the wireless transmitter-receiver 20 to the data server 61 by accessing the data server 61 via the monitor terminal 71.

The monitor terminal 71 can monitor data or control equipment by operating data as necessary, for example by collecting data via a SCADA (Supervisory Control and Data Acquisition) system.

In addition, a cellular telephone 81 is connected to the Internet via a dedicated network provided by a carrier. The wireless transmitter-receiver 20 transmits an e-mail by specifying a cellular telephone 81 that is sending an e-mail, via the SMPT (Simple Mail Transfer Protocol) which is widely used in IP communication. The e-mail may contain sensor information, location information, clock information and the like. Also the wireless transmitter-receiver 20 may determine a threshold for the sensor information, and sends an alarm via an e-mail if the sensor information exceeds the threshold.

Herewith, a person possessing the cellular telephone 81 can monitor the sensor information of the measured object 11, or receive information via an e-mail immediately when abnormal conditions are detected.

That is, the wireless transmitter-receiver itself can transmit an e-mail directly to a PC or a cellular telephone by SMTP protocol. Here, SMTP stands for Simple Mail Transfer Protocol, and is a protocol for sending an e-mail over the Internet. If the sensor network does not support SMTP protocol, it requires more time and cost because data has to be sent from a wireless terminal to a mail server first, and then the mail server sends the e-mail. In this embodiment, although the mobile object may travel to any of the buildings, the wireless transmitter-receiver itself can send an e-mail without sending data to a specific mail server, which spares a need for installing a mail server as well as time and cost.

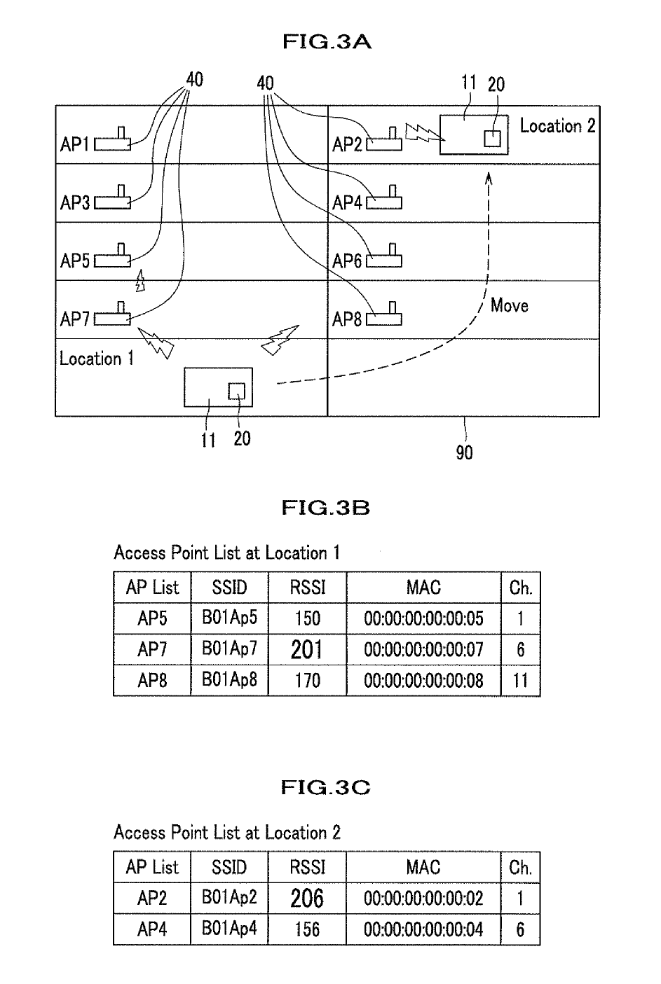

FIGS. 3A to 3C are diagrams for explaining an authentication method of a wireless LAN access point 40 for a mobile object (a measured object 11 with a wireless transmitter-receiver 20 thereon) moving in a building 90 in accordance with an embodiment of the present invention.

FIG. 3A is a diagram for showing relations between a trace of a mobile object moving inside the building 90 (dashed line: an arrow denotes a direction of the move) and a wireless LAN access points 40. In other words, FIG. 3A shows a case in which a measured object 11 as a mobile object and a wireless transmitter-receiver 20 attached thereon move inside the building 90. The table in FIG. 3B is a wireless LAN access point list scanned at a location 1 of FIG. 3A. The table in FIG. 3C is a wireless LAN access point list scanned at a location 2 of FIG. 3A.

Meanwhile, in the embodiment of FIG. 3A, there are access points AP1, AP3, AP5, and AP7 at the location 1; and there are access points AP2, AP4, AP6, and AP8 at the location 2. However, the number of locations and the number of access points are not limited to this manner.

While the mobile object is traveling from the location 1 to the location 2 via the dashed line, the wireless transmitter-receiver 20 on the mobile object performs scanning at a certain location during the travel, and if a pre-registered and authenticatable wireless LAN access point is found in the building 90, the wireless transmitter-receiver 20 creates a scanning result list.

First, by scanning access points at the location 1, the access points AP5, AP7, and AP8 are found and a list is created including an SSID, an RSSI, a MAC address, and a channel for each access point (FIG. 3B).

Looking in detail at RSSI, which represents a radio field intensity, the RSSI of the access point AP7 has the highest value, which shows that the wireless transmitter-receiver 20 is located close to the access point AP7. Although the RSSI may be affected by circumstances of the location 1 such as radio wave environment, the structure of the building, setting environment and so forth, it can be considered that the wireless transmitter-receiver 20 is located close to the access point AP7.

Next, scanning is performed after the measured object 11 traveling from the location 1 to location 2. As a result, the access point AP2 and AP4 are found, and lists for each location are created with respect to an SSID, an RSSI, a MAC address, and a channel (FIG. 3C).

Looking in detail at RSSI, which represents a radio field intensity, the RSSI of the access point AP2 has the highest value, which shows that the wireless transmitter-receiver 20 is located close to the access point AP2.

In many cases, a wireless transmitter-receiver is disposed in a mobile object and driven with a battery. When driven with a battery, it is important to reduce operation time of a wireless function whose power consumption is very high. The channel number provided by IEEE802.11 is 13 to 14. For example, when a beacon signal is transmitted from a wireless LAN access point in every 10 ms, there is a remarkable difference in power consumption between, a case when scanning all channels which takes 130 ms to 140 ms, and a case when scanning a few channels. Considering the operation with a battery, it is preferable to reduce the time for wireless scanning which takes high power consumption as short as possible.

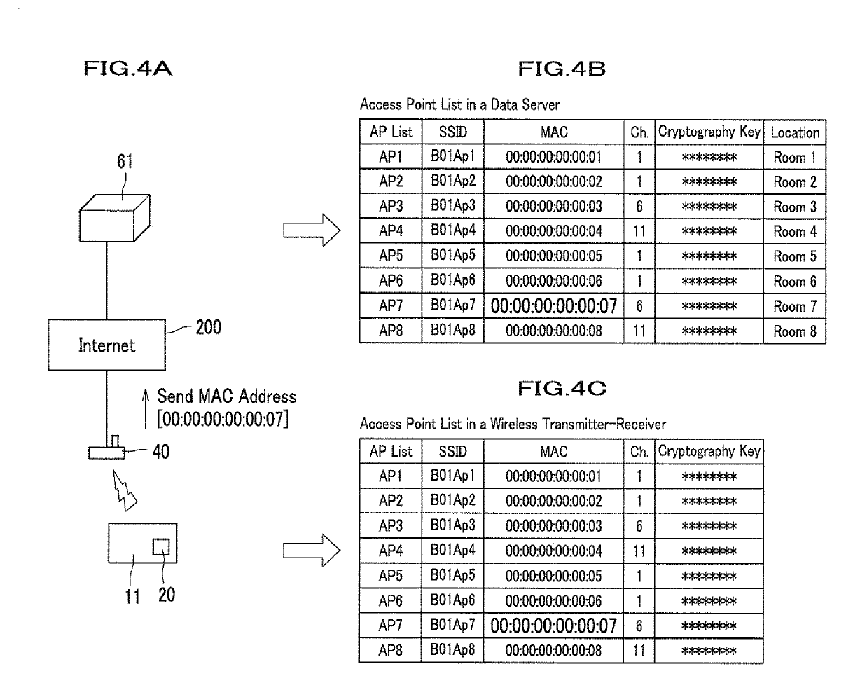

For this purpose, the wireless transmitter-receiver according to the present invention registers in advance a list as authenticatable wireless LAN access point information, the list including an SSID, a MAC address, cryptography key, a wireless channel, and building information. Firstly, the wireless transmitter-receiver finds a building in which the wireless transmitter-receiver is present by scanning all channels. From the next time, the wireless transmitter-receiver scans channels used by the wireless LAN access point in the building only, whereby switching the wireless LAN access point in an efficient fashion with low power consumption is allowed. Hereinafter, this process will be described with reference to FIGS. 4A to 4C.

FIGS. 4A to 4C are diagrams for explaining an embodiment of a wireless LAN access point list and a location mechanism according to the present invention. FIGS. 4A to 4C show an aspect in which the wireless transmitter-receiver 20 transmits data to a data server via the Internet, a wireless LAN access point list in a Data Server, and a wireless LAN access point list in a Wireless Transmitter-Receiver.

In FIGS. 4A and 4C, the wireless transmitter-receiver 20 performs authentication and connection with a wireless LAN access point whose RSSI is the highest according to the scan result, and transmits a data packet including information of the wireless LAN access point (MAC address) to the data server.

In the case of FIGS. 4A to 4C, the wireless transmitter-receiver 20, which is connected to the access point AP7, transmits a packet to the data server 61 including a MAC address of the access point AP7 “00:00:00:00:00:07” via the access point AP7 and the Internet 200.

In this case, as shown in FIG. 4B, the data server 61 has the same wireless LAN access point information (FIG. 4C) as that of the wireless transmitter-receiver 20, therefore the data server 61 can associate the wireless LAN access point information and location information of the wireless LAN access point.

In FIG. 4B, a room name is registered as location information, for example the access point AP7 is registered with Room 7, and therefore the wireless transmitter-receiver 2 is considered to be located in Room 7.

Herewith, it is possible to know the location of the wireless transmitter-receiver 20 by checking the wireless LAN access point in the building 90 to which the wireless transmitter-receiver 20 is connected even when the wireless transmitter-receiver 20 is located inside the building and cannot acquire location information from a GPS. In addition, if the wireless transmitter-receiver 20 is inside the coverage area of a wireless LAN access point, the wireless transmitter-receiver may not communicate with a GPS satellite even when the location information is available from the GPS. Therefore, it is possible to prevent the increase of power consumption due to the operation of the GPS, and to recognize a heightwise difference like floors of a building which is difficult to obtain from the GPS.

As described in the embodiment above, the wireless transmitter-receiver according to the present invention registers in advance a list for authenticatable wireless LAN access point information; the list including an SSID, a MAC address, a cryptography key, a wireless channel, and building information where the wireless LAN access point is installed. Firstly, the wireless transmitter-receiver finds a building in which the wireless transmitter-receiver is present by scanning all channels. From the next time, the wireless transmitter-receiver scans only channels used in the wireless LAN access point installed in the building, whereby switching the wireless LAN access point in an efficient fashion with low power consumption is allowed.

In other words, according to the embodiment of FIGS. 4A to 4C, it is not required to scan all wireless channels every time. Instead, after identifying a building where the wireless transmitter-receiver is located, the wireless transmitter-receiver scans necessary channels only, which enables reducing the scanning time and power consumption, and switching the wireless LAN access point in an efficient fashion.

According to the embodiment 1 above, by utilizing a wireless LAN, it is possible to reduce cost and time for constructing an infrastructure, and to transmit data directly to the Internet via wireless LAN access points disposed in various places.

In addition, if the communication with a GPS satellite is available, it is possible to obtain location information from the GPS satellite, and record sensor information therewith. In addition, if the wireless transmitter-receiver is in the coverage area of a wireless LAN access point, location information while traveling inside the coverage area of a wireless LAN access point becomes available, including detailed information like room location, and this provides better traceability.

Besides the embodiment 1, other embodiments 2 to 6 will be explained using a wireless transmitter-receiver having the structure explained in FIG. 1. A type and quantity of a sensor used in the wireless transmitter-receiver may vary depending on a situation like what kind of status of a measured object is to be detected.

### Embodiment 2

In a wireless transmitter-receiver of Embodiment 2 according to the present invention, a memory unit is a rewritable and erasable nonvolatile memory such as an EEPROM. Sensor information, location information, and clock information are stored in the memory unit when wireless communication is not available. Upon a wireless LAN access point becoming accessible, the stored sensor information, location information, and clock information are transmitted altogether, which allows acquiring various types of information acquired while the wireless transmitter-receiver is outside the coverage area of a wireless LAN access point.

That is, in Embodiment 2, a rewritable and erasable nonvolatile memory such as an EEPROM is used as the memory unit 29 explained in the embodiment in FIG. 1.

Sensor information, location information, and clock information are stored in the memory unit 29 when wireless communication is not available. Upon a wireless LAN access point becoming accessible, the stored sensor information, location information, and clock information are transmitted altogether. Herewith, the wireless transmitter-receiver 20 can transmit various types of information collected while the wireless transmitter-receiver was outside a coverage area of a wireless LAN access point.

In addition, in the wireless transmitter-receiver of Embodiment 2 according to the present invention, a mobile object 10 is for example a track for transportation, and a sensor type is for example a humidity/temperature sensor or an acceleration sensor attached to cargo in the track. A status of the cargo during transportation is monitored by using the sensor information.

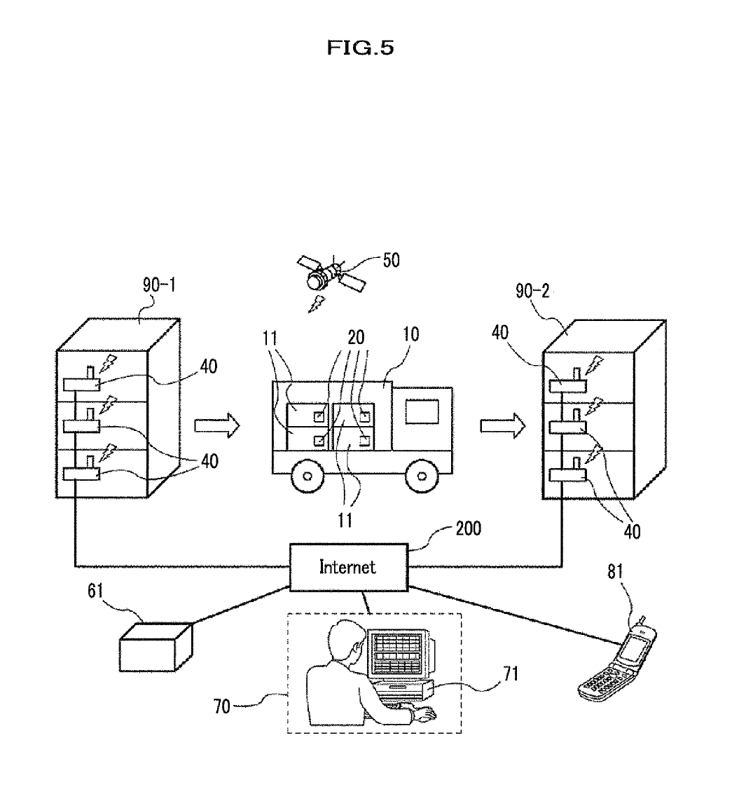

Next, FIG. 5 is a diagram for explaining a structure of an embodiment of a mobile object management system according to the present invention. Numeric characters 90-1 and 90-2 denote a building, 10 a mobile object, 50 a GPS satellite respectively. Although the GPS satellite 50 usually requires information from three GPS satellites, only a single GPS satellite is shown in FIG. 5 for simplicity.

FIG. 5 shows a mobile object management system in addition to the conditions of the embodiment in FIG. 2, in which: there are two buildings 90-1 and 90-2 apart from each other, a track 10 travels between the buildings, first a measured object 11 having a wireless transmitter-receiver 20 thereon is located in the building 90-1, then the measured object 11 having a wireless transmitter-receiver 20 thereon is taken in a track, the track travels to the building 90-2, and the measured object 11 having a wireless transmitter-receiver 20 thereon is lift down at a building after traveling. A sensor type disposed in the wireless transmitter-receiver 20 is for example a temperature sensor or an acceleration sensor. In a case when the cargo is food, a temperature may be recorded to see if it became an abnormal temperature. In a case when the cargo is a medical product or a fragile product, acceleration may be monitored to see it became high level during the travel. Then the data with time and location information may be transmitted to a data server. Consequently, it is possible to monitor the mobile object by reading out the data via a monitor station.

Wireless LAN communication is available in the building 90-1 and 90-2, and the each access point 40 is connected to the Internet 200. Even in a case where there are two buildings 90-1 and 90-2 like FIG. 5, if the wireless transmitter-receiver 20 is located in a building and has wireless LAN access point information, it can perform authentication and connection, data transmission, and sending an e-mail.

As shown in FIG. 5, wireless LAN communication is available inside the buildings 90-1 and 90-2, and each wireless LAN access point 40 is connected to the Internet. Thus, as long as the each access point 40 is connected to the Internet, two or more buildings may be supported. In addition, the shape of a building is not limited as long as a wireless LAN access point can be disposed and connected to the Internet.

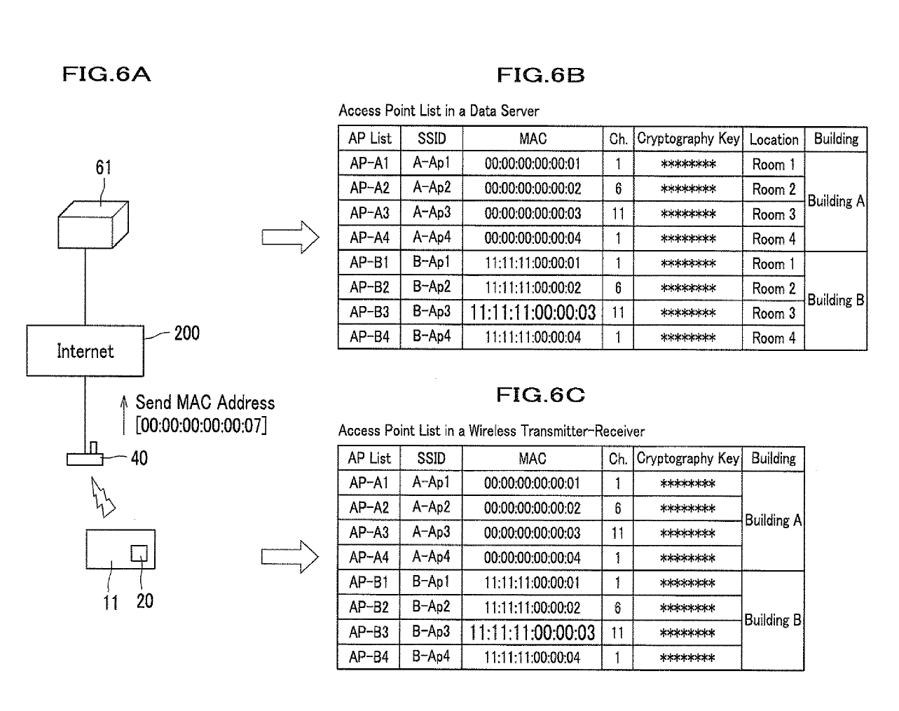

FIGS. 6A to 6C are diagrams for explaining an embodiment of a wireless transmitter-receiver and a mobile object management system according to the present invention.

In FIG. 6A, in a case when there are access points 40 in each building 90-1 and 90-2, a wireless transmitter-receiver 20 may select an appropriate access point by using RSSI or the like, and transmits sensor information, location information, and clock information to a data server 61 via the selected access point and the Internet. Communication method for communication between the measured object 11 located in the building 90-1 or 90-2 and the access point, and between the access point and the data server 61 via the Internet 200 is the same as that of the operation explained in FIG. 2 or 3.

FIG. 6C is an access point list in a wireless Transmitter-Receiver 20, and FIG. 6B is an access point list in the data server 61.

In the same way as FIG. 3, the wireless transmitter-receiver 20 registers in advance a list including authenticatable wireless LAN access point information. In a case when a connection among a plurality of buildings are necessary, the wireless transmitter-receiver registers information that associates a wireless LAN access point information and building information (Building A, Building B).

As shown in FIG. 6B, a wireless LAN access point list registered in the wireless transmitter-receiver 20 includes, access points AP-A1 to AP-A4 in Building A90-1, and access points AP-B1 to AP-B4 in Building B90-2. Herewith, by comparing a scanning result list and a plurality of registered wireless LAN access points 40, and if authenticatable wireless LAN access point 40 is found, it is possible to know which building the wireless transmitter-receiver 20 is present.

In FIG. 6B, assuming that the wireless transmitter-receiver 20 is connected to the access point AP-B3, the wireless transmitter-receiver 20 transmits a packet to the data server 61 including a MAC address of the access point AP-B3 “11:11:11:00:00:03”.

In this case also the data server 61 has building information associated with the wireless LAN access point information and location information of the wireless LAN access point. In FIG. 6B, the list includes room names as location information, a building names as building information. Since the access point AP-B3 are registered to be disposed in Room 3 of Building B, the wireless transmitter-receiver 20 is considered to be located in Room 3 of Building B.

Thus, it is possible to know the location (building and room) of the wireless transmitter-receiver 20 by checking the wireless LAN access point information (MAC address) sent from the wireless transmitter-receiver 20 even when the wireless transmitter-receiver 20 is located inside the building and cannot acquire location information from the GPS.

Hereinafter, a case where a track carrying a measured object 11 having a wireless transmitter-receiver 20 is travelling will be explained by referring to FIG. 5. In this case, the measured object 11 is located neither in the building 90-1 nor in the building 90-2, which means the wireless transmitter-receiver 20 is outside the coverage area of the wireless LAN and wireless communication is not available.

In this case, the Central Processing Unit 34 (see FIG. 1) stores data collected while the wireless transmitter-receiver 20 is outside the coverage area of wireless communication into the memory unit 29 which is constituted by an EEPROM. At this moment for example, the wireless transmitter-receiver 20 is located outdoor and can communicate with the GPS satellite 50, and can acquire location information from the location information acquisition unit (GPS) 24. Therefore, by storing clock information acquired from the real-time clock (clock function unit) 28 with the sensor information, time and location information can be included therewith.

In the embodiment 2 above, when the measured object 11 having a wireless transmitter-receiver 20 attached thereon is carried on a track that is transporting cargo, and if the track is moving and wireless transmitter-receiver 20 cannot communicate with the wireless LAN access point, it is preferable to store the information periodically into the memory unit 29 which is constituted by nonvolatile memory such as EEPROM. When the track 10 arrives at the building 90-2 and gets inside the coverage area of a wireless LAN access point 40, and if there is a wireless LAN access point 40 that is registered to the wireless transmitter-receiver 20, the wireless transmitter-receiver 20 automatically performs authentication and connection with the wireless LAN access point 40 and all data stored so far is transmitted to the data server 61.

As stated above, it is possible to record a status while the track is traveling. In a case when the cargo is food, a temperature may be recorded to see if it became an abnormal temperature, which may help securing food safety. If the cargo is a medical product or a fragile product, the product may be monitored and recorded, for example, with an acceleration sensor to check when and where the product was fell down and broken.

As stated above, even when there are a plurality of buildings, nevertheless indoor or outdoor, it is possible to obtain information when and where (axis, room name) and what was the status of the measured object 11. Here, it is not required to detach the wireless transmitter-receiver 20 from the measured object 11 since it is driven with a battery for a long time, and can be automatically monitored all the time while traveling between or inside the buildings. In addition, the communication cost is very low since it adopts a most commonly used wireless LAN, and it is possible to implement a concise and low cost system capable of utilizing a most common infrastructure.

Consequently, in Embodiment 2, by storing data such as sensor information, location information, and clock information to a memory unit constituted by a nonvolatile memory, and by transmitting the data to a data server when communication with a wireless LAN access point becomes available after traveling, it is possible to obtain a status of the mobile object even in a case in which a wireless LAN infrastructure is not available. For example, an EEPROM is a nonvolatile memory in a form of a small IC (Integrated Circuit) with a maximum memory size approximately 1 MB, and operable in low power dissipation.

### Embodiment 3

In a wireless transmitter-receiver of Embodiment 3 according to the present invention, GPS is used for the location information acquisition unit. Inside the coverage area of a wireless LAN access point, the wireless transmitter-receiver does not acquire location information from the GPS but scans a signal periodically sent from wireless LAN access points, performs authentication and connection with a wireless LAN access point that has the highest field intensity, and acquires wireless LAN access point information. Then the wireless transmitter-receiver packetizes the information and sends the packet to a data server. The data server associates the wireless LAN access point information and location information of the wireless LAN access point in advance. By so doing, more detailed location information can be obtained in addition to the location information from the GPS.

Meanwhile, when the wireless transmitter-receiver is outside the coverage area of the wireless LAN access point, and if communication with a GPS satellite is available, the wireless transmitter-receiver acquires location information from the GPS.

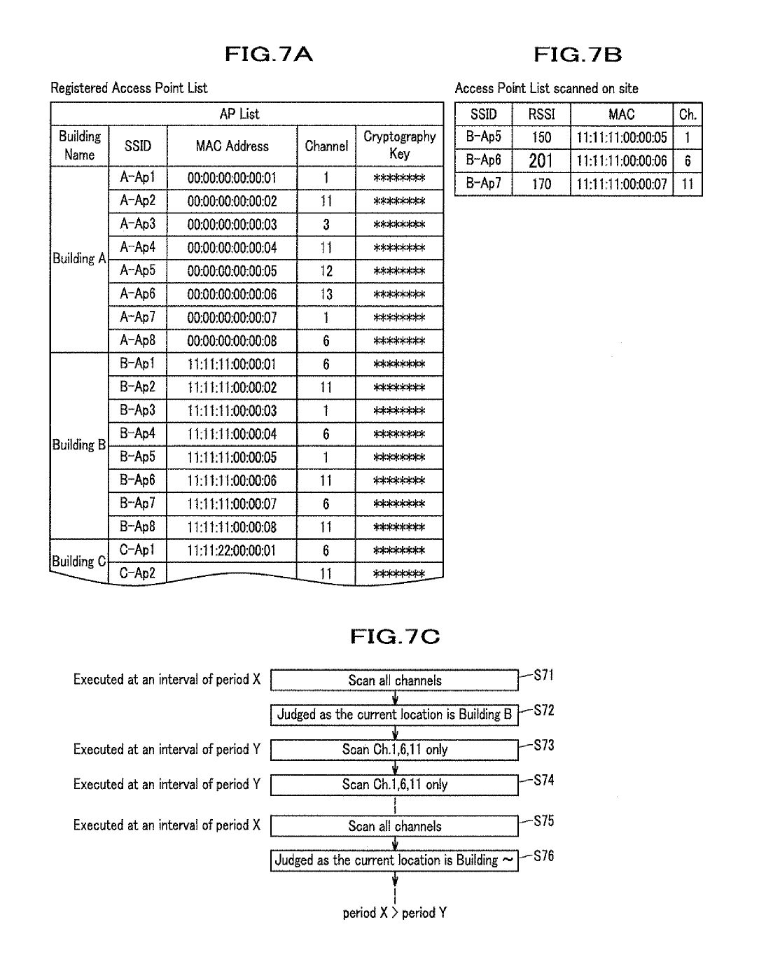

Embodiment 3 according to the present invention will be explained by referring to FIGS. 7A to 7C. FIGS. 7A to 7C are diagrams for explaining an efficiency improvement in scanning a wireless LAN access point when a plurality of buildings are registered in an embodiment of a wireless transmitter-receiver and a mobile object management system according to the present invention. FIG. 7A shows a registered access point list including all registered access points, FIG. 7B shows an access point list scanned on site, and FIG. 7C shows a scanning process.

FIGS. 7A to 7C are diagrams for explaining an efficiency improvement in scanning a wireless LAN access point when a plurality of buildings are registered. Normally, when scanning wireless LAN access points, all channels specified by IEEE802.11 are scanned for creating a wireless LAN access point list. However, scanning all channels requires large scanning time with high power consumption of the wireless LAN, which results in shortening the life of the wireless transmitter-receiver.

To solve the problem in this embodiment, the wireless transmitter-receiver performs scanning all channels first to determine in which building is the wireless transmitter-receiver located.

That is, in FIG. 7C, the wireless transmitter-receiver scans all channels first (S71), judges the location of the building where the measured object 11 is present (S72). For example, the measured object 11 is judged as located in the building B.

As a result of scanning with respect to the building B (S73, S74), the access point list includes the access point B-Ap5, B-Ap7, B-Ap8. According to FIG. 7B, the RSSI of the access point B-Ap7 is highest and therefore the wireless transmitter-receiver performs authentication and connection with the access point B-Ap7.

Here, it can be considered from the registered access point list (FIG. 7A) that the access point B-Ap7 wireless transmitter-receiver is present in the building B, and all the access points in the building B use channels 1,6,11 only.

Therefore, It is determined that only the channel 1,6,11 need to be scanned as long as the wireless transmitter-receiver is located in the building B. As a result, the scanning time can be reduced and the life of the wireless transmitter-receiver can become longer.

After obtaining the building information where the wireless transmitter-receiver is present and restricting the scanning channels, scanning all channels is performed at an interval of period X (S75), and scanning restricted channels 1,6,11 is performed at an interval of period Y. Here, it is assumed that period X is larger than period Y.

In this way, by scanning all channels at an interval of period X, it can handle a situation where the measured object or mobile object moves to another building. For example, if the wireless transmitter-receiver moves to another building, performs scanning all channels, and if it is determined that the location of the measured object is changed to another building, then the wireless transmitter-receiver refers to the registered wireless LAN access point list to see the channels used in the building (after the location is changed), and performs scanning the restricted channels every Y period.

According to Embodiment 3, the wireless transmitter-receiver scans a signal generated periodically from the wireless LAN access point when the wireless transmitter-receiver is inside the coverage area of a wireless LAN access point even when the wireless transmitter-receiver can communicate with a GPS satellite, performs authentication and connection with the wireless LAN access point that has a highest signal level, and acquires wireless LAN access point information. Consequently, the power consumption can be reduced.

### Embodiment 4

In a wireless transmitter-receiver of Embodiment 4 according to the present invention, the Central Processing Unit is equipped with a real-time OS (Operating System), and creates a task for a wireless function and a task other than the wireless function. The Central Processing Unit calls periodically a task other than that of the wireless function when not using the wireless function, and calls periodically the task of the wireless function when using the wireless function. Herewith, it becomes possible to operate the wireless function which requires large amount of power efficiently, and to reduce the power consumption of the wireless transmitter-receiver, allowing the long time operation with a battery.

That is, the wireless transmitter-receiver of an embodiment according to the present invention is equipped with a real-time OS, and creates a plurality of tasks for a wireless function and a function other than the wireless function. Controlling the tasks in detail makes it possible to reduce the power consumption and to operate with a battery for a long time.

For operating the wireless transmitter-receiver efficiently, a plurality of tasks are created. For example, a measurement task for acquiring sensor information, location information, and clock information, and a scan task for performing scanning and authentication/connection, are created and controlled by the real-time OS for performing efficient connection to the wireless LSN access point and performing a measurement.

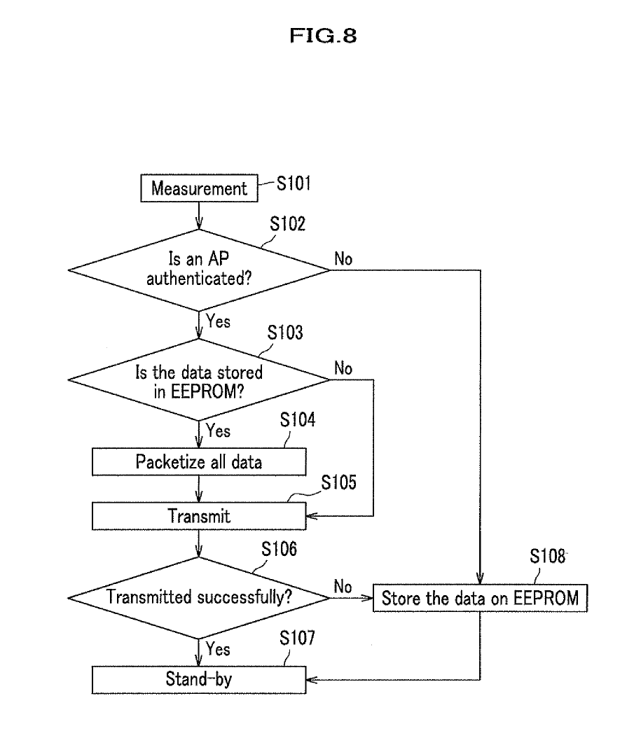

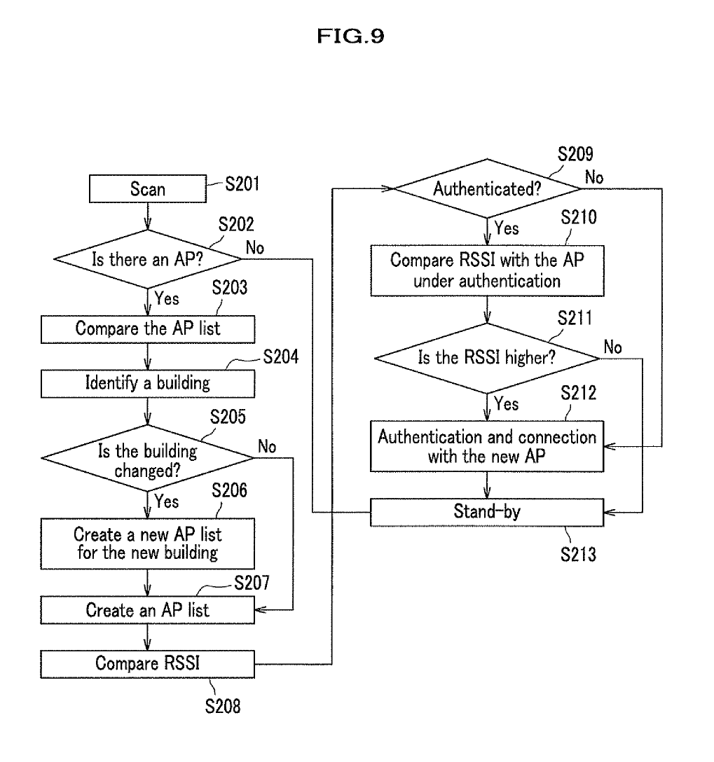

FIG. 8 is a flow chart of a procedure of a measurement task of a wireless transmitter-receiver in accordance with an embodiment of the present invention. When the measurement task is switched from a ready state to a running state under scheduling of the real-time OS, the process S101 acquires sensor information, location information, and clock information. Next the process S102 determines if there is an access point and is authenticated. At this point, comparing an access point list made by another task (i.e. the scan task: see FIG. 9 hereinafter described) and a wireless LAN access point list registered in advance in the wireless transmitter-receiver is performed, and if there is no matched access point, then the process is switched to the process 108. If there is a matched wireless LAN access point list, then the process is switched to S103.

In process S103, it is checked if the data is stored in the memory unit 29 which is constituted by a nonvolatile memory such as EEPROM.

Here, in a case where there is more than one piece of data in the memory unit 29, a packet is prepared at the process S104 including the measurement data acquired at S101 and the stored data, and then the packet is wirelessly transmitted in the process S105.

At S103, if the data is not stored in the memory unit 29, the data measured at S101 is immediately wireless transmitted at S105. At this point, it is checked whether the wireless transmission is completed successfully at S106, and if the wireless transmission is not successful, all the data is stored in the memory unit 29 (S108). In addition, if it is judged sent successfully, the process is switched to stand-by.

That is, the data is stored to the memory unit 29 at S108.

Next, FIG. 9 is a flow chart of a procedure of a scanning task of a wireless transmitter-receiver in accordance with an embodiment of the present invention.

When the scan task switches from the ready state to the running state under the scheduling of the real-time OS, a process S201 performs scanning.

In process S202, the scanned wireless LAN access point list and the wireless LAN access point list registered in the wireless transmitter-receiver are compared, and if there is no matched access point, then the process is switched to a process S213. If there is a matched wireless LAN access point, then the process is switched to a process S203.

At the process S203, the access point and the registered access point list are compared, and then at a process S204 a building in which the wireless transmitter-receiver is located is determined.

In process S205, it is determined whether or not the location of the building is changed (whether the wireless transmitter-receiver is moved to another building). If it is determined not, then in process S207, a wireless LAN access point list based on the access point list of the previous building is created. If it is judged being changed (i.e. the wireless transmitter-receiver moved to another building), the process is switched to a process S206.

The process S206 uses the wireless LAN access point list in the building after the location change, and a process S207 creates a wireless LAN access point list. Next, a process S208 compares RSSI in the wireless LAN access point list. Then, a process S209 judges if the wireless transmitter-receiver is authenticated by the wireless LAN access point. If it is not authenticated, the process is switched to a process S212. If it is authenticated, the process is switched to a process S210.

A process S210 compares the wireless LAN access point under authentication and a wireless LAN access point list having highest RSSI compared by the process S208.

In a process S211, if the wireless LAN access point having the highest RSSI compared by the process S208 has lower RSSI than that of the wireless LAN access point under authentication, then the process is switched to a process S213.

A process S212 performs authentication with the new wireless LAN access point, and then the process is switched to the process S213.

When the scan task is activated next time, this new wireless LAN access point becomes the wireless LAN access point under authentication.

By so doing, the method using the real-time OS for controlling each task efficiently shortens the operating time of the terminal, reduces the power consumption by switching the state of the terminal to the stand-by state when not in operation, which makes long time operation with a battery possible even when using a wireless LAN the power consumption of which is relatively high for a near field wireless communication means, and which enables the application to long-distance transportation. Here, the real-time OS is not a regular program which executes functions sequentially, but a special program specialized in resource management in particular protecting a time resource and predicting an execution time, which is an essential character of an OS. Each function is assigned to an object called a task, and each task issues a service call to the OS, and the OS performs scheduling tasks according to the priority of the tasks. A user can feel as if each function is operating in real-time. In the present invention, for example, a wireless function and an application function for acquiring sensor information are divided into a wireless task and an application task, and are controlled under the OS. By scheduling each function efficiently, it is possible to reduce the power consumption.

### Embodiment 5

A wireless transmitter-receiver of Embodiment 5 according to the present invention registers in advance an ID and a password for authentication using the HTTP (Hyper Text Transfer Protocol), in addition to an SSID, a MAC address, a cryptography key, and a wireless channel of a public wireless LAN access point, whereby automatic authentication and connection is allowed as long as the wireless transmitter-receiver is inside the coverage area of the public wireless LAN access point.

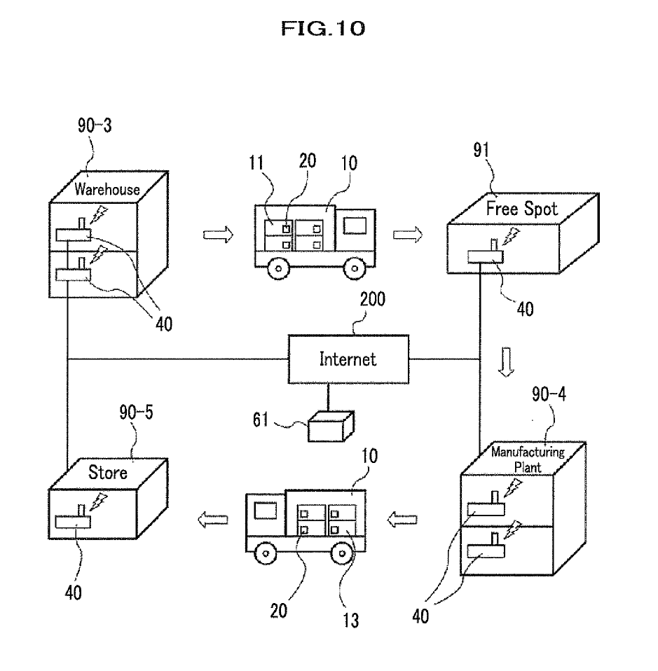

FIG. 10 is a diagram of a mobile object management system including a service area of a public wireless LAN access point in accordance with an embodiment of the present invention. A numeric character 90-3 denotes a warehouse, 90-4 a manufacturing plant, 90-5 a store, 91 a free spot, and 13 denotes a measured object respectively.

The warehouse 90-3, manufacturing plant 90-4, and store 90-5 are areas each having a wireless LAN access point disposed therein. The warehouse 90-3 stores raw material, and the material is processed in the manufacturing plant 90-4. Then the processed food is laid out for sale in the store 90-5. The free spot 91 is a building with a wireless LAN access point service area disposed therein.

FIG. 10 shows how a mobile object 10 such as a track transports a measured object 11 having a wireless transmitter-receiver 20 thereon between buildings.

Each raw material stored in the warehouse 90-3 has a wireless transmitter-receiver 20 attached thereon as a measured object 11, and is carried on the mobile object 10. The mobile object 10 passes through the free spot 91 and transports the raw material to the manufacturing plant 90-4 and unloads the raw material. The raw material is processed in the manufacturing plant 90-4, and a wireless transmitter-receiver 20 is attached to the processed product as a measured object 13, and then the measured object 13 is carried on the mobile object 10. The mobile object 10 transports the processed products to the store 90-5 and unloads them. The store 90-5 rearrange the processed products into finished goods, attaches a measured object 11 and a wireless transmitter-receiver 20 to each product, and then displays the product or stores them in a storage in the store.

The raw material, the processed product, and the finished good may be, for example, food.

It is required to monitor the sanitary conditions of the raw material, the processed product, and the finished good. For this purpose, a sensor that detects a humidity/temperature is used for monitoring the humidity/temperature during the transportation. In this case, if there is an available wireless service area (for example, the free spot 91) during the transportation and a wireless LAN access point is registered in the wireless transmitter-receiver, it is possible to perform authentication and connection with the wireless LAN access point and transmit data while traveling.

The free spot is an example of a public wireless LAN service, which is defined by the FREESPOT council, a public area in which a wireless LAN access point is disposed, and is available everywhere. For example, the free spot is disposed in, a SS(Service Area) or PA (Parking Area) in a highway, a roadside station, an airport, a vending machine, a library, a hotel, an inn, a restaurant, and the like that requested the installation.

The wireless transmitter-receiver 20 can, as long as it registers in advance wireless LAN access point information for the public wireless LAN service area, perform authentication and connection, and transmits data by entering the public wireless LAN service area in a similar way to a normal wireless LAN access point. However, for using some services, it may be required to login by entering a user name and password using the HTTP protocol, depending on a service of the public wireless LAN. In a case when connecting from a PC, it is necessary to perform authentication using the HTTP protocol manually via a browser. However, if the information is registered in advance to the wireless transmitter-receiver, it is possible to perform the authentication via the HTTP protocol automatically.

In FIG. 10, although a single wireless LAN access point service area is shown, there may a plurality of service areas as long the service areas are supported by the same carrier and if the same login name and password are provided, it is possible to perform the authentication and connection using the same information. In addition, although the public wireless LAN service area is a free spot in this embodiment, even when it is supported by another carrier or another association, it may be possible to perform the authentication and connection as long as the information is registered in the wireless transmitter-receiver.

In this way, it is a big advantage to use a wireless LAN having an infrastructure available everywhere, and a public wireless LAN service allows implementing the present system with low cost.

Consequently, it becomes possible to transmit data in most places in large cities by using a public wireless LAN service available anywhere in addition to a wireless LAN access point in a building.

The embodiment above uses a FREESPOT defined by FREESPOT council as a public wireless LAN service, and connected to a wireless LAN access point in a public are (a station, a public office, an accommodation, a café etc.) and the wireless LAN connected thereto. Authentication to a public wireless LAN access point from a PC is performed manually via a browser using HTTP protocol. If an ID and a password are registered to the wireless transmitter-receiver in advance, it is possible to perform authentication automatically using the HTTP protocol, which allows an automatic connection to the Internet upon entering a public wireless LAN service area.

### Embodiment 6

In a wireless transmitter-receiver of Embodiment 6 according to the present invention, the mobile object is a human, and a sensor is a body temperature or a pulse sensor for monitoring a health condition of the human.

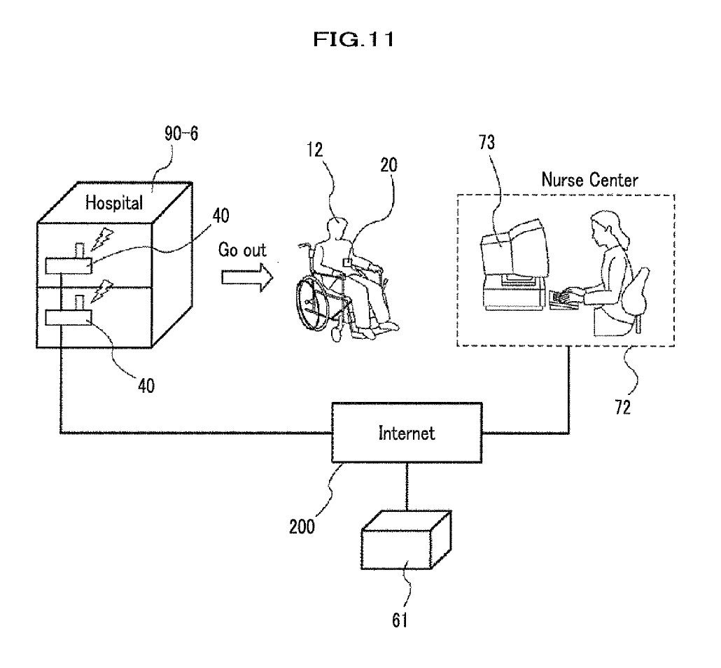

FIG. 11 is a diagram for explaining an embodiment of a wireless transmitter-receiver and a mobile object management system according to the present invention. The wireless LAN access point is located in a hospital 90-6, and there is a human 12 having a wireless transmitter-receiver 20. The human 12 travels in and around the hospital freely. In addition, there is a data server 61 in the Internet, and a monitor terminal 73 in a monitoring point, i.e. a nurse center 70. Hospital staff members can monitor health conditions of a plurality of patients (a human 12) and locations with time information.

In this case, a sensor is, for example, a body temperature sensor or a pulse sensor. If a patient is located in the hospital 90-6, the physical condition can be monitored. Accordingly, it is determined that the patient is in the hospital. Once the patient goes out, it means that the patient is outside the coverage area of a wireless LAN access point, and then it is determined that the patient is out of the hospital. When the patient returns to the hospital 90-6 and enters into the coverage area of a wireless LAN access point, the data collected while the patient is out is transmitted, and the condition while the patient is out can be monitored.

By so doing, in a hospital or a welfare facility, a person having a sensor attached can be monitored automatically not only when he/she is inside the facility but also when he/she is outside the facility. In addition, a doctor or a nurse can see an event such that the patient goes out or returns.

In the Embodiment 6 above, the mobile object is a human. However, the mobile object may be an animal in a farm, and a sensor may be a body temperature sensor or a pulse sensor for monitoring the animal.

According to the embodiment above, by attaching a sensor to an animal in the farm, a health condition of the animal can be monitored, which allows early detection of a disease and prevent infection and decrease of animals, and improves the production efficiency. As a result, in-depth health management helps providing high quality foodstuff.

In addition, a mobile object can be a human or an animal if not a material object as far as it can be transportable. For example, it may be cattle, and monitoring a health condition of the cattle may help growing a high quality cattle.

As stated in the embodiment above, the wireless transmitter-receiver according to the present invention is disposed in a mobile object, and the mobile object is a measured object by a sensor in a wireless transmitter-receiver, and the wireless transmitter-receiver sends sensor information, location information, and clock information acquired from the mobile object.

A wireless transmitter-receiver in accordance with an embodiment of the present invention operates in a standing condition as well as in moving condition. In addition, if the wireless transmitter-receiver is disposed on a mobile object, the wireless transmitter-receiver can acquire the status of the mobile object, location information, and clock information covering all the time regardless the mobile object is moving or standing still.

Further, by transmitting data from a wireless terminal to a data server directly via the Internet and monitoring it on a monitor terminal, it is possible to record a status of a measured object on the mobile object indicating in what time and in what condition, regardless indoor or outdoor.

The present invention has been explained in detail referring to the embodiments. However, the embodiments of the present invention are not limited to those explanations, and those skilled in the art ascertain the essential characteristics of the present invention and can make the various modifications and variations to the present invention to adapt it to various usage and conditions without departing from the spirit and scope of the claims.

What is claimed is:

1. A wireless transmitter-receiver, comprising:
a sensor that acquires one or more pieces of information;
a location information acquisition unit;
a clock information acquisition unit;
a clock function unit that stores the clock information;
a wireless LAN transmitter-receiver unit; and
a central processing unit that controls each unit;
wherein the wireless transmitter-receiver periodically and wirelessly transmits the sensor information, the location information, and the clock information within a coverage area where a wireless LAN access point is accessible.

2. The wireless transmitter-receiver according to claim 1 further comprising a memory unit including a writable and erasable nonvolatile memory, wherein:
the memory unit stores the sensor information, the location information, and the clock information in a case when the wireless transmitter-receiver is outside the coverage area of the wireless LAN access point or when wireless communication is not available; and
the central processing unit controls the wireless LAN transmitter-receiver unit to transmit the sensor information, the location information, and the clock information stored in the memory unit, upon the wireless LAN transmitter-receiver unit becoming connectable to the wireless LAN access point.

3. The wireless transmitter-receiver according to claim 1, wherein:
the location information acquisition unit is a GPS;
the wireless transmitter-receiver performs under control of the Central Processing Unit,
acquiring location information from the GPS in a case when the wireless transmitter-receiver can communicate with a GPS satellite and is outside the coverage area of the wireless LAN access point,
and in a case when the wireless transmitter-receiver is inside the coverage area of the wireless LAN access point even though the wireless transmitter-receiver can communicate with the GPS satellite,
not acquiring location information from the GPS,
scanning a signal generated periodically from the wireless LAN access point,
authenticating and connecting with the wireless LAN access point that has a highest signal level,
acquiring wireless LAN access point information,
transmitting the sensor information, the location information, and the clock information via a data packet to a data server; and
the data server acquires more detailed location information in addition to the location information from the GPS by making correspondence in advance between a wireless LAN access point and location information thereof.

4. The wireless transmitter-receiver according to claim 1, wherein the Central Processing Unit performs:
registering information for an authentication of the wireless LAN access point in advance, the information including an SSID, a MAC address, a cryptography key, a wireless channel, and building information where the wireless LAN access point is installed;
firstly, finding a building where the wireless transmitter-receiver is present using a scanning result of all channels scanned by the wireless LAN transmitter-receiver unit;
and from a next time, scanning only channels used in the wireless LAN access point installed in the building.

5. The wireless transmitter-receiver according to claim 1, wherein the Central Processing Unit includes a real-time OS and performs: creating a task for a wireless function and a task other than the wireless function, calling periodically the task other than the wireless function when not using the wireless function, and calling periodically the task for the wireless function when using the wireless function.

6. The wireless transmitter-receiver according to claim 3,
wherein:
the clock information acquisition unit acquires a clock time using an NTP protocol under control of the Central Processing Unit;
the location information acquisition unit acquires clock information from the GPS if the wireless transmitter-receiver can communicate with the GPS satellite and is outside the coverage area of the wireless LAN access point;
the location information acquisition unit does not acquire location information from the GPS but acquires a Coordinated Universal Time from the NTP server via the NTP protocol if the wireless transmitter-receiver is inside the coverage area of the wireless LAN access point even if the wireless transmitter-receiver can communicate with the GPS satellite; and
the acquired clock information is stored in the clock function unit;
the wireless transmitter-receiver acquires clock information from the clock function unit in a case when the wireless transmitter-receiver cannot communicate with the GPS satellite and is outside the coverage area of the wireless LAN access point.

7. The wireless transmitter-receiver according to claim 1, wherein:
the wireless LAN transmitter-receiver unit communicates wirelessly with a general purpose wireless LAN access point via IP communication and transmits data to a data server over the Internet under control of the Central Processing Unit, whereby the wireless transmitter-receiver monitors the sensor information, the location information, and the clock information.

8. The wireless transmitter-receiver according to claim 1, wherein the wireless LAN transmitter-receiver unit transmits an e-mail including the sensor information, the location information, the clock information, and alarm, to a cellular telephone or a personal computer directly using a SMTP protocol without intervention of a mail server.

9. The wireless transmitter-receiver according to claim 1, wherein the Central Processing Unit performs:
registering to a public wireless LAN access point in advance an SSID, a MAC address, a cryptography key, and a wireless channel of the public wireless LAN access point;
registering, in addition to the information above, an ID and a password for authentication using an HTTP protocol; and
controlling the wireless LAN transmitter-receiver unit for performing authentication and connection automatically if the wireless transmitter-receiver is inside the coverage area of the wireless LAN access point.

10. The wireless transmitter-receiver according to claim 1 wherein: the wireless transmitter-receiver is installed in a mobile object; the mobile object is a measured object of the sensor; and the wireless transmitter-receiver transmits the sensor information, the location information, and the clock information, acquired from the mobile object.

11. The wireless transmitter-receiver according to claim 10 wherein: the mobile object is a transportation vehicle; the sensor includes a humidity/temperature sensor or an acceleration sensor disposed on a cargo of the vehicle for monitoring a status of the cargo.

12. The wireless transmitter-receiver according to claim 10 wherein: the mobile object is a human body; the sensor includes a body temperature sensor or a pulse sensor for monitoring a status of the human body.

13. The wireless transmitter-receiver according to claim 10 wherein: the mobile object is an animal body; the sensor includes a body temperature sensor or a pulse sensor for monitoring a status of the animal body.

14. A mobile object management system comprising:
a data server connected to the Internet;
a wireless transmitter-receiver disposed on a mobile object and connected to the Internet; and
a monitor terminal connected to the Internet; wherein:
the data server is accessible from the monitor terminal for browsing as an ASP (Application Service Provider;
the wireless transmitter-receiver includes, a sensor that acquires one or more pieces of information, a location information acquisition unit, a clock information acquisition unit, a clock function unit that stores the clock information, a wireless LAN transmitter-receiver unit, and a central processing unit that controls each unit; and
the wireless transmitter-receiver transmits the sensor information, the location information, and the clock information periodically and wirelessly within a coverage area of a wireless LAN access point.

15. The wireless transmitter-receiver according to claim 2, wherein:
the location information acquisition unit is a GPS; and
the Central Processing Unit controls the wireless transmitter-receiver for,
acquiring location information from the GPS in a case when the wireless transmitter-receiver can communicate with a GPS satellite and is outside the coverage area of the wireless LAN access point,
scanning a signal generated periodically from the wireless LAN access point when the wireless transmitter-receiver is inside the coverage area of the wireless LAN access point even when the wireless transmitter-receiver can communicate with the GPS satellite,
authenticating and connecting with the wireless LAN access point that has a highest signal level,
acquiring wireless LAN access point information,
transmitting the sensor information, the location information, and the clock information via a data packet to a data server;
and wherein the data server acquires more detailed information in addition to the location information from the GPS by making correspondence between a wireless LAN access point and location information thereof in advance.

16. The wireless transmitter-receiver according to claim 2, wherein the Central Processing Unit performs:
registering information for an authentication of the wireless LAN access point in advance, the information including an SSID, a MAC address, a cryptography key, a wireless channel, and building information where the wireless LAN access point is installed;
firstly, locating a building where the wireless transmitter-receiver is located using a scanning result of all channels scanned by the wireless LAN transmitter-receiver unit;
and from a next time, scanning a channel used by the wireless LAN access point in the located building only.

17. The wireless transmitter-receiver according to claim 2, wherein:
the wireless LAN transmitter-receiver unit communicates wirelessly with a general purpose wireless LAN access point via IP communication and transmits data to a data server over the Internet under control of the Central Processing Unit, whereby the wireless transmitter-receiver monitors the sensor information, the location information, and the clock information.

18. The wireless transmitter-receiver according to claim 2, wherein the wireless LAN transmitter-receiver unit transmits an e-mail including the sensor information, the location information, the clock information, and alarm, to a cellular telephone or a personal computer directly using a SMTP protocol without intervention of a mail server.

19. The wireless transmitter-receiver according to claim 2, wherein the Central Processing Unit performs:
registering to a public wireless LAN access point in advance an SSID, a MAC address, a cryptography key, and a wireless channel of the public wireless LAN access point;
registering, in addition to the information above, an ID and a password for authentication using an HTTP protocol; and
controlling the wireless LAN transmitter-receiver unit for performing authentication and connection automatically if the wireless transmitter-receiver is inside the coverage area of the wireless LAN access point.

20. The wireless transmitter-receiver according to claim 2 wherein: the wireless transmitter-receiver is installed in a mobile object; the mobile object is a measured object of the sensor; and the wireless transmitter-receiver transmits the sensor information, the location information, and the clock information, acquired from the mobile object.
